(19) United States
(12) Patent Application Publication
(10) Pub. No.: US 2020/0036640 A1
(43) Pub. Date: Jan. 30, 2020

(54) SUPPRESSION OF A TRAFFIC AMOUNT BETWEEN AN INFORMATION PROCESSING DEVICE AND HOST DEVICES

(71) Applicant: FUJITSU LIMITED, Kawasaki-shi (JP)

(72) Inventors: Masanori NAGANUMA, Yokohama (JP); Shohei YAMAMOTO, Kawasaki (JP)

(73) Assignee: FUJITSU LIMITED, Kawasaki-shi (JP)

(21) Appl. No.: 16/517,034

(22) Filed: Jul. 19, 2019

(30) Foreign Application Priority Data
Jul. 30, 2018 (JP) 2018-142335

(51) Int. Cl. H04L 12/813; H04L 12/801; H04L 12/823

(52) U.S. Cl. CPC H04L 47/20; H04L 47/323; H04L 47/13

(57) ABSTRACT

An information processing device stores a plurality of first programs applicable to the information processing device, and communicates with a plurality of higher-level devices. When a connection process is executed between a higher-level device and the information processing device, the information processing device transmits program information indicating the plurality of first programs to the higher-level device. The higher-level device determines whether a predetermined first program, which is applicable to the information processing device and associated with a second program applied to the higher-level device, is to be transmitted to the information processing device, based on whether the program information includes information on the predetermined first program, and transmits, to the information processing device, an instruction for causing the information processing device to apply the predetermined first program when the higher-level device determines that the predetermined first program is not to be transmitted to the information processing device.

### CROSS-REFERENCE TO RELATED APPLICATION

This application is based upon and claims the benefit of priority of the prior Japanese Patent Application No. 2018-142335, filed on Jul. 30, 2018, the entire contents of which are incorporated herein by reference.

### FIELD

The embodiment relates to suppression of a traffic amount between an information processing device and host devices.

### BACKGROUND

In a system in which a host device and an information processing device execute a mutual communication process with each other, a program applied to the host device and a program applied to the information processing device are updated to associate the programs with each other. For example, the program of the host device and the program of the information processing device are synchronized with each other by transmitting the latest program from the host device to the information processing device.

As a related technique, a technique for detecting the version of software compatible with new firmware and selecting software of a version to be newly used has been proposed (refer to, for example, Japanese Laid-open Patent Publication No. 2014-191797).

As another related technique, a technique for updating firmware of a printing device when version information of the firmware of the printing device is different from version information of firmware managed by a managing section has been proposed (refer to, for example, Japanese Laid-open Patent Publication No. 2009-230400).

As another related technique, a technique for determining consistency between an installed printer driver and an installed control program and a new-version printer driver and a new-version control program and for updating the installed printer driver and the installed control program has been proposed (refer to, for example, Japanese Laid-open Patent Publication No. 2001-27940).

### SUMMARY

According to an aspect of the embodiments, an information processing system includes an information processing device, and a plurality of higher-level devices with which the information processing device communicates. The information processing device stores a plurality of first programs applicable to the information processing device. When a connection process is executed between each of the plurality of higher-level devices and the information processing device, the information processing device transmits program information indicating the plurality of first programs to the higher-level device. The higher-level device stores a predetermined first program that is applicable to the information processing device and associated with a second program applied to the higher-level device. The higher-level device determines whether the predetermined first program is to be transmitted to the information processing device, based on whether the program information received from the information processing device includes information on the predetermined first program, and transmits, to the information processing device, an instruction for causing the information processing device to apply the predetermined first program when the higher-level device determines that the predetermined first program is not to be transmitted to the information processing device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an entire configuration of an information processing system according to an embodiment;

FIG. 2 is a diagram illustrating an example of each of host devices;

FIG. 3 is a diagram illustrating an example of an information processing device;

FIG. 4 is a diagram illustrating an example of association information indicating association relationships between first programs and second programs;

FIG. 5 is a diagram illustrating an example of management information indicating first programs stored in a storage unit of the information processing device;

FIG. 6 is a flowchart of an example of a process to be executed by each of the host devices;

FIG. 7 is a flowchart of an example of a process to be executed by the information processing device;

FIG. 8 is a flowchart of an example of a process of S206 illustrated in FIG. 7;

FIG. 9 is a diagram illustrating a first state according to the embodiment;

FIG. 10 is a diagram illustrating a second state according to the embodiment;

FIG. 11 is a diagram illustrating a third state according to the embodiment;

FIG. 12 is a diagram illustrating a fourth state according to the embodiment;

FIG. 13 is a diagram illustrating an example of a hardware configuration of each of the host devices; and

FIG. 14 is a diagram illustrating an example of a hardware configuration of the information processing device.

### DESCRIPTION OF EMBODIMENTS

For example, it is assumed that a system including an information processing device connectable to and able to communicate with multiple host devices exists. It is considered that, in the system, when a first host device that is connected to and communicates with the information processing device is switched to a second host device to be connected to and able to communicate with the information processing device, the information processing device receives, from the second host device, a program complying with the second host device to which the information processing device is newly connected. However, when the information processing device receives a program for another host device which is to be connected to and able to communicate with the information processing device, each time a host device that is connected to and communicating with the information processing device is switched to the another host device, a traffic amount increases.

It is preferable to suppress a traffic amount between the information processing device and multiple host devices.

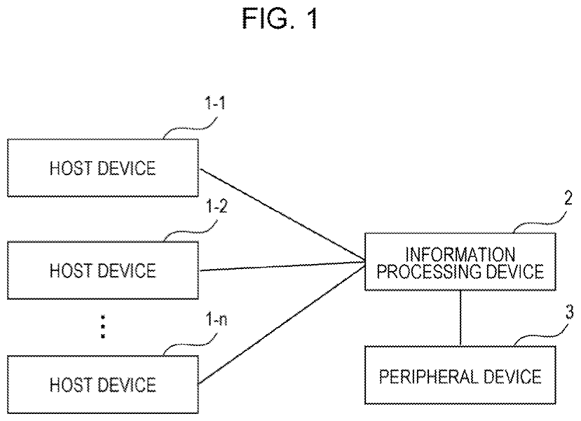

Hereinafter, an embodiment is described with reference to the accompanying drawings. FIG. 1 is a diagram illustrating an example of an entire configuration of an information processing system according to the embodiment. The information processing system includes host devices 1-1, 1-2, . . . , and 1-n, an information processing device 2, and a peripheral device 3. Hereinafter, when the host devices 1-1, 1-2, . . . , and 1-n are not distinguished from each other, the host devices 1-1, 1-2, . . . , and 1-n are referred to as host devices 1. The information processing device 2 is connectable to and able to communicate with the host devices 1 via a network such as a local area network (LAN) or a wide area network (WAN). The information processing device 2 is coupled to the peripheral device 3 via a network such as a LAN or an interface such as a Universal Serial Bus (USB) interface.

The host devices 1 are main flames, for example. The host devices 1 are an example of high-level devices. The information processing device 2 is, for example, a server, a personal computer, or the like. The peripheral device 3 is, for example, a printing device, a display device, a storage device, or the like.

Each of the host devices 1 may execute a mutual communication process with the information processing device 2 coupled to and able to communicate with the host device 1 and may use the peripheral device 3 via the information processing device 2. The information processing system illustrated in FIG. 1 makes a program applied to the host device 1 and a program applied to the information processing device 2 compatible with each other before the host device 1 executes the mutual communication process with the information processing device 2. The program applied to the information processing device 2 is hereinafter referred to as first program. In addition, the program applied to the host devices 1 is hereinafter referred to as second program.

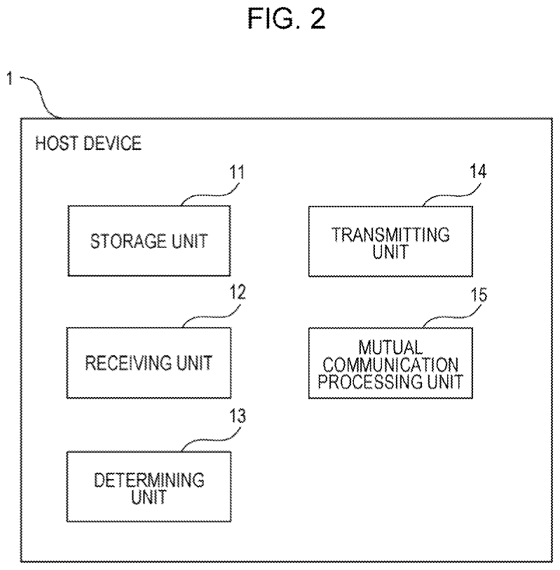

FIG. 2 is a diagram illustrating an example of each of the host devices 1. Each of the host devices 1 includes a storage unit 11, a receiving unit 12, a determining unit 13, a transmitting unit 14, and a mutual communication processing unit 15.

The storage unit 11 stores a second program applied to the host device 1 and a first program associated with the second program applied to the host device 1. Hereinafter, the first program associated with the second program applied to the host device 1 is also referred to as predetermined first program. The storage unit 11 also stores association information indicating association relationships between second programs and first programs. The storage unit 11 is an example of a second storage unit.

The second program is, for example, firmware for controlling hardware of the host device 1. The second program may be an operating system (OS), an application to be executed on the OS, or the like, for example.

When the information processing device 2 is connected to and communicates with the host device 1, the receiving unit 12 receives management information that includes program information indicating first programs stored in the information processing device 2 and information indicating the first program applied to the information processing device 2.

The determining unit 13 determines whether the predetermined first program is to be transmitted to the information processing device 2, based on whether the program information received from the information processing device 2 indicates the predetermined first program.

When the host device 1 executes a connection process between the host device 1 and the information processing device 2, the transmitting unit 14 transmits, to the information processing device 2, an instruction to transmit the program information indicating the multiple first programs stored in the information processing device 2 and applicable to the information processing device 2. The transmitting unit 14 is an example of a second transmitting unit.

When the determining unit 13 determines that the predetermined first program is to be transmitted to the information processing device 2, the transmitting unit 14 transmits the predetermined first program stored in the storage unit 11 to the information processing device 2.

For example, when the first program applied to the information processing device 2 is not the predetermined first program, and the predetermined first program is included in the management information, the determining unit 13 determines that the predetermined first program is not to be transmitted to the information processing device 2. Then, the transmitting unit 14 transmits, to the information processing device 2, an instruction to apply the predetermined first program stored in the information processing device 2. This allows the host device 1 to associate the first program to be applied to the information processing device 2 with the second program applied to the host device 1 and to suppress a traffic amount between the host device 1 and the information processing device 2.

For example, when the first program applied to the information processing device 2 is not the predetermined first program, and the predetermined first program is not indicated in the management information, the determining unit 13 determines that the predetermined first program is to be transmitted to the information processing device 2. Then, the transmitting unit 14 transmits the predetermined first program to the information processing device 2 and transmits, to the information processing device 2, an instruction to apply the transmitted predetermined first program. This allows the host device 1 to associate the first program to be applied to the information processing device 2 with the second program applied to the host device 1.

For example, when the first program applied to the information processing device 2 is the predetermined first program, the determining unit 13 determines that the predetermined first program is not to be transmitted to the information processing device 2. Then, the transmitting unit 14 transmits, to the information processing device 2, an instruction to execute a predetermined mutual communication process. This allows the host device 1 to start executing the mutual communication process without transmitting a useless program.

The mutual communication processing unit 15 executes the predetermined mutual communication process with the information processing device 2 after the transmitting unit 14 transmits, to the information processing device 2, an instruction to execute the predetermined mutual communication process. For example, when the peripheral device 3 is a printing device and the host device 1 uses the peripheral device 3, the mutual communication processing unit 15 transmits and receives various types of data on printing to and from the information processing device 2.

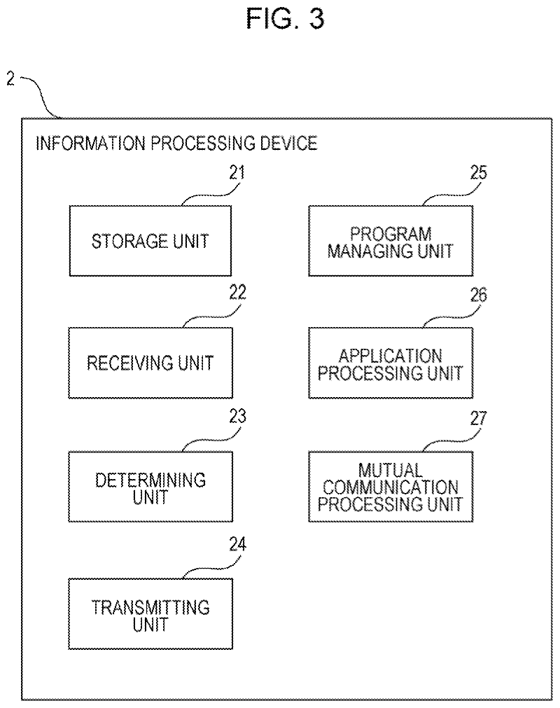

FIG. 3 is a diagram illustrating an example of the information processing device 2. The information processing device 2 includes a storage unit 21, a receiving unit 22, a determining unit 23, a transmitting unit 24, a program managing unit 25, an application processing unit 26, and a mutual communication processing unit 27.

The storage unit 21 stores, in a first region, one or more first programs applicable to the information processing device 2 and stores, in a second region, the management information indicating the one or more first programs stored in the first region. The storage unit 21 is an example of a first storage unit.

The first programs are, for example, firmware for controlling hardware of the information processing device 2. The first programs may be OSs, applications to be executed on the OSs, or the like, for example.

The receiving unit 22 receives the predetermined first program transmitted by the host device 1. The receiving unit 22 receives the instruction to apply the predetermined first program transmitted by the host device 1, the instruction to execute the predetermined mutual communication process, and the like.

The determining unit 23 determines whether the receiving unit 22 has received the predetermined first program. In addition, the determining unit 23 determines whether the receiving unit 22 has received the instruction to apply the predetermined first program from the host device 1.

When the information processing device 2 executes the connection process with any of the multiple host devices 1, the transmitting unit 24 transmits, to the host device 1, the program information related to the multiple first programs and included in the management information and information indicating the first program applied to the information processing device 2. The transmitting unit 24 is an example of a first transmitting unit.

When the receiving unit t22 receives the predetermined first program from the host device 1, and the number of first programs stored in the first region of the storage unit 21 is equal to a predetermined value, the program managing unit 25 deletes any of the first programs stored in the first region. In this case, the program managing unit 25 deletes a first program used at the earliest time point among time points when the first programs were used last, and causes the received predetermined first program to be stored in the first region. The predetermined value is, for example, equal to the maximum number of first programs able to be stored in the first region.

When the receiving unit 22 receives, from the host device 1, the instruction to apply the predetermined first program stored in the information processing device 2, the application processing unit 26 applies the predetermined first program stored in the storage unit 21 to the information processing device 2.

When the receiving unit 22 receives, from the host device 1, the first predetermined program and the instruction to apply the predetermined first program, the application processing unit 26 applies the received predetermined first program to the information processing device 2.

When the receiving unit 22 receives, from the host device 1, the instruction to execute the predetermined mutual communication process, the mutual communication processing unit 27 executes the predetermined mutual communication process with the host device 1. For example, when the peripheral device 3 is a printing device and the host device 1 uses the peripheral device 3, the mutual communication processing unit 27 transmits and receives various types of data on printing to and from the host device 1. The mutual communication processing unit 27 executes the mutual communication process after the termination of a session process. For example, the host device 1 transmits, to the information processing device 2, a command to confirm a state of the information processing device 2 in a session start process, and the information processing device 2 transmits a command indicating the state (“ready”, “busy”, or the like) to the host device 1.

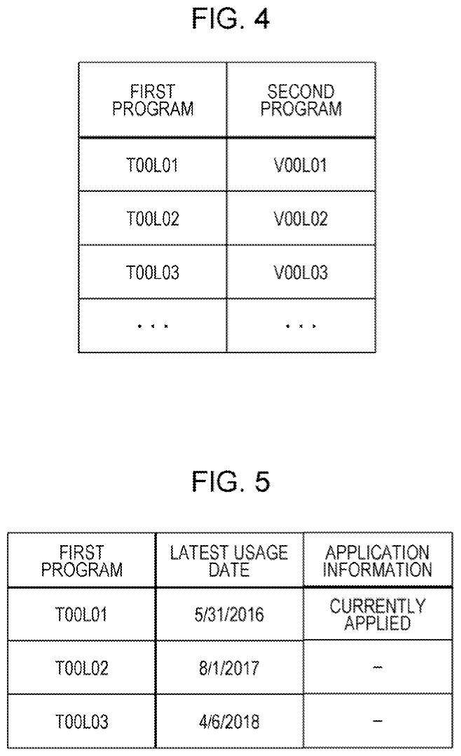

FIG. 4 is a diagram illustrating an example of the association information indicating the association relationships between the second programs and the first programs. The storage unit 11 stores, as the association information, data used in a table illustrated in FIG. 4. The association information illustrated in FIG. 4 indicates identification information indicating the second programs and identification information indicating the first programs associated with the second programs. The identification information indicating the second programs and the identification information indicating the first programs include version information of the programs.

In the example illustrated in FIG. 4, a second program “V00L01” and a first program “T00L01” are associated with each other, a second program “V00L02” and a first program “T00L02” are associated with each other, and a second program “V00L03” and a first program “T00L03” are associated with each other. For example, a combination of a second program that has been normally operated in the past and a first program that has been normally operated in the past is recorded as the programs associated with each other in the association information illustrated in FIG. 4.

The association information illustrated in FIG. 4 indicates one-to-one association relationships. However, for example, when a second program is associated multiple first programs, the association information illustrated in FIG. 4 may indicate one-to-N (N is an integer of 2 or more) association relationships.

The association information illustrated in FIG. 4 indicates the association relationships between all the second programs and all the first programs. Each of the host devices 1 may store only identification information indicating a first program associated with a second program applied to the host device 1.

FIG. 5 is a diagram illustrating an example of the management information indicating first programs stored in the storage unit 21 of the information processing device 2. The storage unit 21 stores, as the management information, data used in a table illustrated in FIG. 5 in the second region. The management information illustrated in FIG. 5 includes identification information indicating the first programs stored in the storage unit 21, the latest dates when the first programs have been used, and application information indicating whether the first programs are being applied. The identification information indicating the first programs stored in the storage unit 21 and the application information indicating whether the first programs are being applied are an example of program information.

When the receiving unit 22 receives the predetermined first program from the host device 1, the program managing unit 25 determines whether the number of first programs stored in the first region of the storage unit 21 is equal to the predetermined value. When the number of first programs stored in the first region of the storage unit 21 is equal to the predetermined value, the program managing unit 25 references the management information and deletes a first program used at the earliest time point among time points when the first programs were used last (for example, a latest usage date illustrated in FIG. 5).

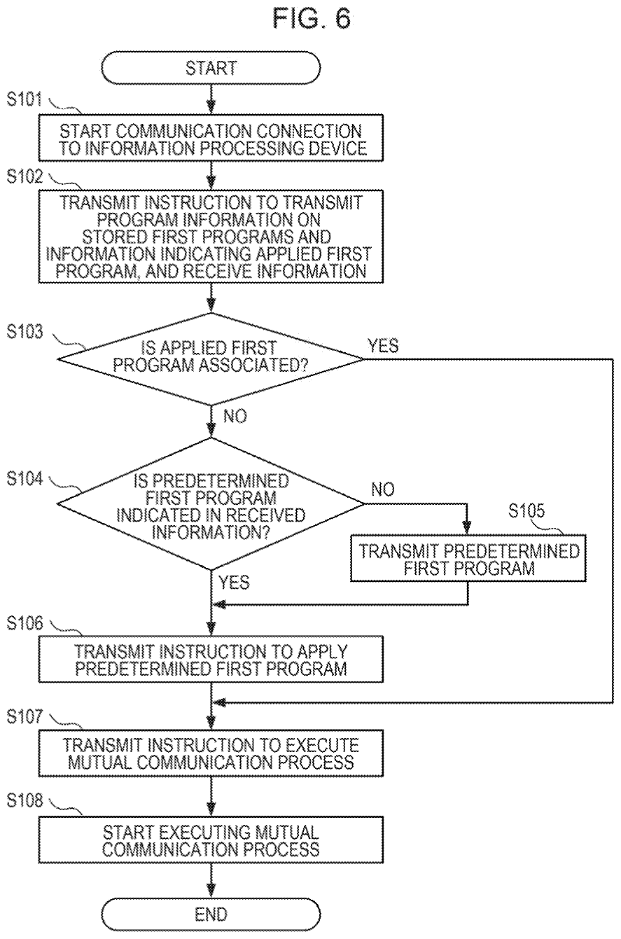

FIG. 6 is a flowchart of an example of a process to be executed by each of the host devices 1. A host device 1 starts a process illustrated in FIG. 6 when the host device 1 is connected to and communicates with the information processing device 2 due to switching from a connection to another host device 1. Alternatively, the host device 1 starts the process illustrated in FIG. 6 when the host device 1 or the information processing device 2 is reactivated, or when communication between the host device 1 and the information processing device 2 is disconnected and restored, or the like.

The host device 1 transmits a connection request to the information processing device 2 and starts a session (communication) with the information processing device 2 (in step S101). For example, the host device 1 transmits, to the information processing device 2, a command to confirm the state of the information processing device 2, and the information processing device 2 transmits a command indicating the state (“ready”, “busy”, or the like) to the host device 1.

The transmitting unit 14 transmits, to the information processing device 2, an instruction for causing the information processing device 2 to transmit program information indicating the first programs, which are stored in the storage unit 21 and applicable to the information processing device 2, and information on a first program currently applied to the information processing device 2, and the receiving unit 12 receives the information from the information processing device 2 (in step S102). The program information received in step S102 is, for example, a portion that is included in the management information illustrated in FIG. 5 and indicates identification information of the first program.

The determining unit 13 determines whether the first program applied to the information processing device 2 is a program (predetermined first program) associated with a second program applied to the host device 1 (in step S103). For example, the determining unit 13 makes the determination of step S103 by referencing the association information illustrated in FIG. 4 and the information received in step S102.

When the answer to step S103 is NO, the determining unit 13 determines whether the predetermined first program is indicated in the application information received in step S102 (in step S104).

When the answer to step S104 is NO, the determining unit 13 determines that the predetermined first program is to be transmitted to the information processing device 2. Then, the transmitting unit 14 transmits the predetermined first program to the information processing device 2 (in step S105).

When the answer to step S104 is YES, the determining unit 13 determines that the predetermined first program is not to be transmitted to the information processing device 2. When the answer to step S104 is YES or after the process of step S105, the transmitting unit 14 transmits, to the information processing device 2, an instruction to apply the predetermined first program (in step S106). When the answer to step S104 is YES and the process proceeds to step S106, the transmitting unit 14 transmits, to the information processing device 2, an instruction to apply the predetermined first program stored in the information processing device 2. When the process proceeds to step S106 after the process of step S105, the transmitting unit 14 transmits, to the information processing device 2, an instruction to apply the predetermined first program transmitted in step S105.

When the answer to step S103 is YES or after the process of step S106, the transmitting unit 14 transmits, to the information processing device 2, an instruction to execute the predetermined mutual communication process (in step S107). Then, the mutual communication processing unit 15 starts executing the predetermined mutual communication process (in step S108).

In the aforementioned manner, the host device 1 determines whether a first program is to be transmitted to the information processing device 2, based on whether the predetermined first program is indicated in the received program information. Since the host device 1 does not transmit a program already held in the information processing device 2, the host device 1 may suppress a traffic amount and quickly start the mutual communication process. In addition, the information processing system according to the embodiment may suppress a traffic amount and reduce a network load in the entire system. This may improve the convenience of a user who uses the information processing system.

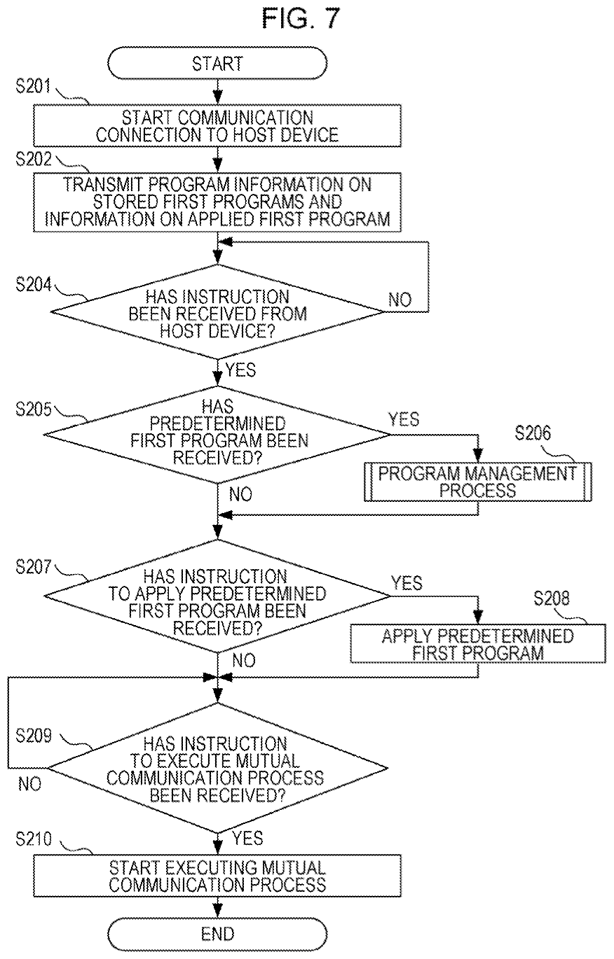

FIG. 7 is a flowchart of an example of a process to be executed by the information processing device 2. When the information processing device 2 receives a communication connection request from the host device 1, the information processing device 2 starts a process illustrated in FIG. 7. The process illustrated in FIG. 7 is executed in parallel with the process illustrated in FIG. 6.

The information processing device 2 is connected to and communicates with the host device 1 and starts a session (in step S201). The transmitting unit 24 transmits, to the host device 1, program information indicating the first programs stored in the storage unit 21 and information on a first program currently applied to the information processing device 2 (in step S202). The program information transmitted in step S202 is, for example, a portion that is included in the management information illustrated in FIG. 5 and indicates identification information of the first program.

The determining unit 23 determines whether the receiving unit 22 has already received, from the host device 1, an instruction to apply a program or an instruction to execute the mutual communication process (in step S204). When the answer to step S204 is NO, the information processing device 2 stands by. When the answer to step S204 is YES, the determining unit 23 determines whether the receiving unit 22 has received a program (predetermined first program) associated with the second program applied to the host device 1 (in step S205). When the receiving unit 22 has received the predetermined first program (YES in step S205), the program managing unit 25 executes a program management process (in step S206). The program management process is described later in detail.

When the receiving unit 22 has not received the predetermined first program (NO in step S205), or after the process of step S206, the determining unit 23 determines whether the receiving unit 22 has received, from the host device 1, an instruction to apply the predetermined first program (in step S207).

When the receiving unit 22 has received, from the host device, the instruction to apply the predetermined first program (YES in step S207), the application processing unit 26 applies the predetermined first program (in step S208). The application processing unit 26 applies the predetermined first program to the information processing device 2 by using the predetermined first program to reboot the information processing device 2. When the receiving unit 22 has already received, from the host device 1, the instruction to apply the predetermined first program, the application processing unit 26 applies the received predetermined first program to the information processing device 2. When the receiving unit 22 receives, from the host device 1, the instruction to apply the predetermined first program stored in the information processing device 2, the application processing unit 26 applies the predetermined first program stored in the storage unit 21 to the information processing device 2.

When the answer to step S207 is NO or after the process of step S208, the determining unit 23 determines whether the receiving unit 22 has received, from the host device 1, an instruction to execute the mutual communication process (in step S209). When the receiving unit 22 has not received, from the host device 1, the instruction to execute the mutual communication process (NO in step S209), the information processing device 2 stands by until the receiving unit 22 receives the instruction to execute the mutual communication process.

When the receiving unit 22 has received the instruction to execute the mutual communication process (YES in step S209), the mutual communication processing unit 27 starts executing the mutual communication process (in step S210).

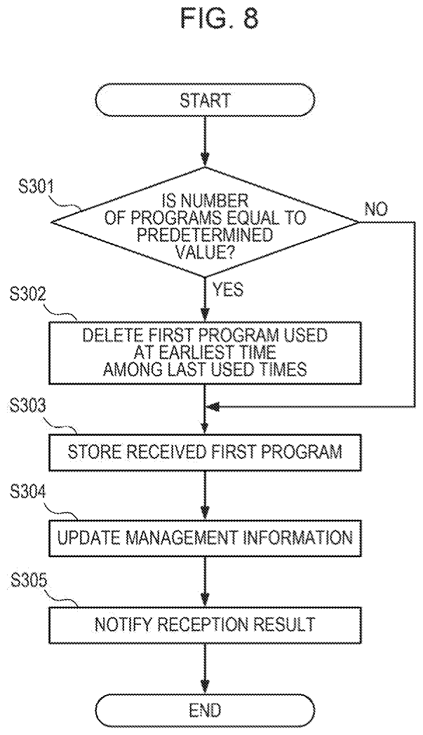

FIG. 8 is a flowchart of an example of the process of S206 illustrated in FIG. 7. The program managing unit 25 determines whether the number of first programs stored in the first region of the storage unit 21 is equal to the predetermined value (in step S301). The predetermined value is, for example, equal to the maximum number of first programs that are able to be stored in the first region. When the answer to step S301 is YES, the program managing unit 25 references the management information and deletes a first program used at the earliest time point among time points when the first programs stored in the first region were used last (in step S302). The time points when the first programs were used last are, for example, latest usage dates indicated in the management information illustrated in FIG. 5.

When the answer to step S301 is NO or after the process of step S302, the program managing unit 25 causes the first program received from the host device 1 to be stored in the first region of the storage unit 21 (in step S303).

The program managing unit 25 updates the management information (in step S304). For example, the program managing unit 25 adds identification information indicating the received predetermined first program to the management information. For example, when the first program is deleted in S302, the program managing unit 25 deletes, from the management information, identification information indicating the deleted first program.

When the program managing unit 25 confirms the validity of the received predetermined first program, the program managing unit 25 notifies the host device 1 of a reception result indicating that the valid program has been received (in step S305).

It is considered that the first program used at the earliest time point among the time points when the first programs were used last is applied with the lowest probability among the stored first programs. Thus, the program managing unit 25 deletes the first program used at the earliest time point among the time points when the first programs were used last, thereby reducing a capacity to be used by the storage unit 21 and suppressing a reduction in the probability that a first program within the storage unit 21 is applied.

### EXAMPLE

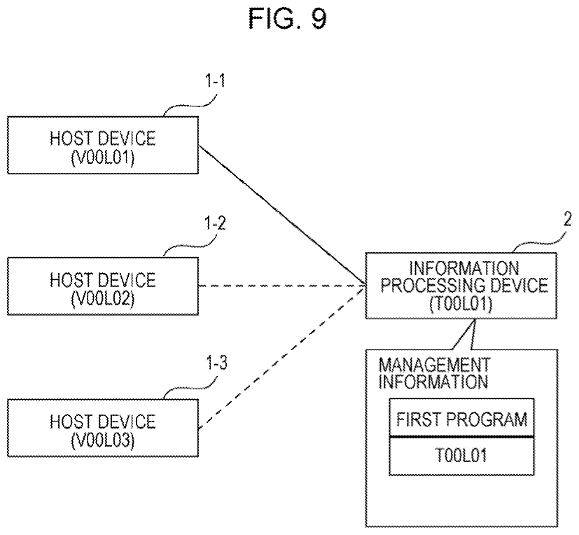

Next, an example in which a host device 1 that is connected to and communicates with the information processing device 2 is switched to another host device to be connected to and able to communicate with the information processing device 2 is described with reference to FIGS. 9 to 12. In FIGS. 9 to 12, identification information enclosed in parentheses and added to host devices 1 indicates second programs applied to the host devices 1. Similarly, in FIGS. 9 to 12, identification information enclosed in parentheses and added to the information processing device 2 indicates first programs applied to the information processing device 2. In each of FIGS. 9 to 12, a solid line between a host device 1 and the information processing device 2 indicates that the host device 1 and the information processing device 2 are connected to and communicate with each other, and broken lines between host devices 1 and the information processing device 2 indicate that the host devices 1 and the information processing device 2 are not connected to and unable to communicate with each other. In FIGS. 9 to 12, an illustration of the peripheral device 3 is omitted. In management information illustrated in FIGS. 9 to 12, an illustration of latest usage dates is omitted.

FIG. 9 is a diagram illustrating a first state according to the embodiment. As illustrated in FIG. 9, the information processing system according to the embodiment includes host devices 1-1, 1-2, and 1-3 and the information processing device 2. In the first state, the host device 1-1 and the information processing device 2 are connected to and communicate with each other. In the first state, the first program “T00L01” is stored in the storage unit 21 of the information processing device 2, “T00L01” is recorded in the management information, and the first program “T00L01” is being applied to the information processing device 2.

As indicated by the association information illustrated in FIG. 4, since the second program “V00L01” applied to the host device 1-1 is associated with the first program “T00L01” applied to the information processing device 2, the host device 1-1 does not transmit a first program to the information processing device 2.

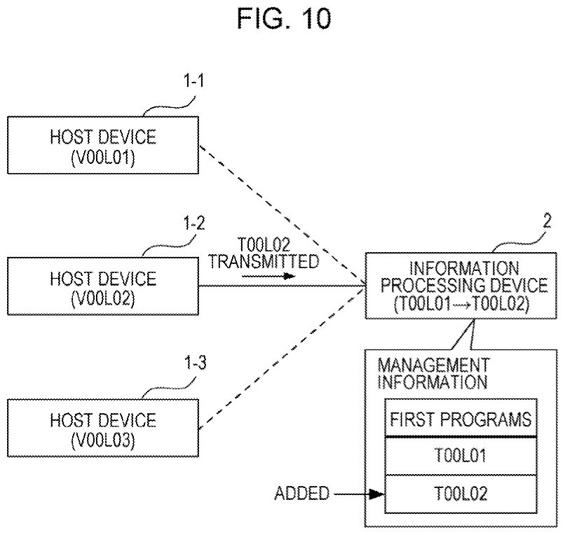

FIG. 10 is a diagram illustrating a second state according to the embodiment. In the second state, the host device 1-2 is connected to and communicates with the information processing device 2 after the host device 1-1 in the first state illustrated in FIG. 9 disconnects the communication connection to the information processing device 2. As illustrated in FIG. 4, a first program associated with the second program “V00L02” applied to the host device 1-2 is “T00L02”. It is assumed that when the host device 1-2 is connected to and communicates with the information processing device 2, the first program “T00L02” is not applied to the information processing device 2 and is not included in the management information of the information processing device 2.

Since the first program “T00L02” associated with the second program is not indicated in the management information, the transmitting unit 14 of the host device 1-2 transmits the first program “T00L02” to the information processing device 2. Then, the program managing unit 25 of the information processing device 2 causes the first program “T00L02” to be stored in the storage unit 21 and adds “T00L02” to the management information. Then, the application processing unit 26 applies the first program “T00L02” to the information processing device 2.

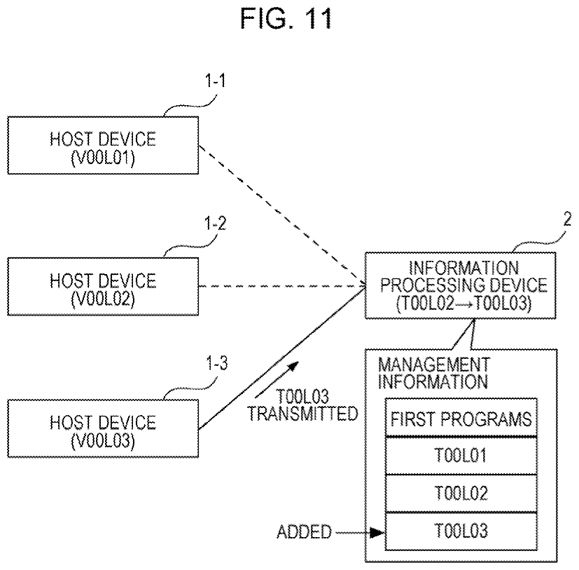

FIG. 11 is a diagram illustrating a third state according to the embodiment. In the third state, the host device 1-3 is connected to and communicates with the information processing device 2 after the host device 1-2 in the second state illustrated in FIG. 10 disconnects the communication connection to the information processing device 2. As illustrated in FIG. 4, a first program associated with the second program “V00L03” applied to the host device 1-3 is “T00L03”. It is assumed that when the host device 1-3 is connected to and communicates with the information processing device 2, the first program “T00L03” is not applied to the information processing device 2 and is not indicated in the management information.

Since the first program “T00L03” associated with the second program is not indicated in the management information, the transmitting unit 14 of the host device 1-3 transmits the first program “T00L03” to the information processing device 2. Then, the program managing unit 25 of the information processing device 2 causes the first program “T00L03” to be stored in the storage unit 21 and adds “T00L03” to the management information. Then, the application processing unit 26 applies the first program “T00L03” to the information processing device 2.

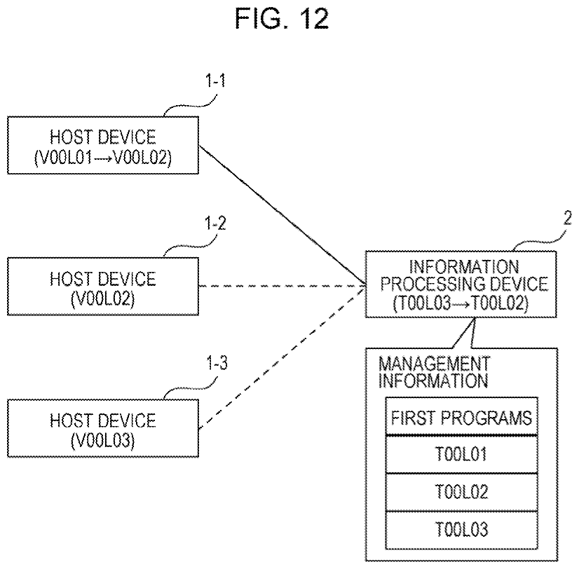

FIG. 12 is a diagram illustrating a fourth state according to the embodiment. In the fourth state, the host device 1-1 is connected to and communicates with the information processing device 2 after the host device 1-3 in the third state illustrated in FIG. 11 disconnects the communication connection to the information processing device 2. It is assumed that a second program to be applied is changed from “V00L01” to “V00L02” before the host device 1-1 is connected to and communicates with the information processing device 2.

As illustrated in FIG. 4, a first program associated with the second program “V00L02” applied to the host device 1-1 is “T00L02”. It is assumed that when the host device 1-1 is connected to and communicates with the information processing device 2, the first program “T00L02” is not applied to the information processing device 2 but is indicated in the management information.

Since the first program “T00L02” associated with the second program is indicated in the management information, the transmitting unit 14 of the host device 1-1 does not transmit a first program to the information processing device 2. Then, the application processing unit 26 of the information processing device 2 applies, to the information processing device 2, the first program “T00L02” stored in the storage unit 21.

When a host device 1 connected to and communicates with the information processing device 2 is switched to another host device 1 to be connected to and able to communicate with the information processing device 2, the information processing device 2 holds a first program associated with a second program of the previously connected host device 1. Then, the first program held in the information processing device 2 may be associated with a second program of the host device 1 that is newly connected to and communicates with the information processing device 2. In an example illustrated in FIG. 12, the host device 1-1 does not transmit a first program, and a first program stored in the information processing device 2 is applied to the information processing device 2. Thus, the information processing system according to the embodiment may suppress a traffic amount between the host devices 1 and the information processing device 2.

Hardware Configurations

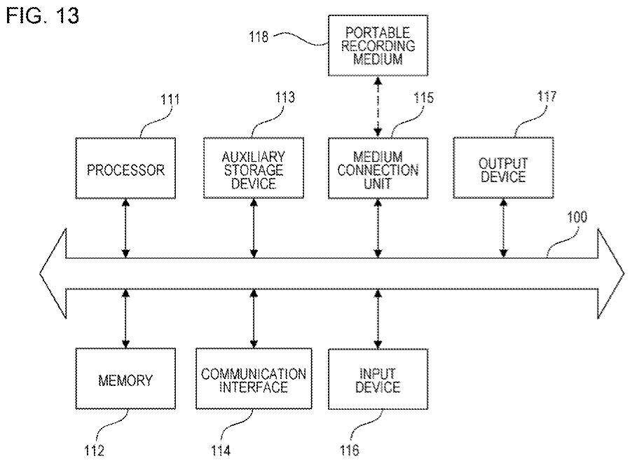

Next, a hardware configuration of each of the host devices 1 and a hardware configuration of the information processing device 2 are described. FIG. 13 is a diagram illustrating an example of the hardware configuration of each of the host devices 1. As illustrated in FIG. 13, in each of the host devices 1, a processor 111, a memory 112, an auxiliary storage device 113, a communication interface 114, a medium connection unit 115, an input device 116, and an output device 117 are coupled to a bus 100.

The processor 111 executes a program loaded in the memory 112. As the program to be executed, a program for executing the processes of the host device 1 according to the embodiment may be applied.

The memory 112 is, for example, a random access memory (RAM). The auxiliary storage device 113 stores various types of information. As the auxiliary storage device 113, a hard disk drive, a semiconductor memory, or the like may be applied, for example. The program for executing the processes of the host device 1 according to the embodiment may be stored in the auxiliary storage device 113.

The communication interface 114 is coupled to a communication network such as a LAN or a WAN and converts data for communication. When the receiving unit 12 receives various types of information from the information processing device 2, and the transmitting unit 14 transmits various types of information to the information processing device 2, the host device 1 executes communication to the information processing device 2 via the communication interface 114.

The medium connection unit 115 is an interface to which a portable recording medium 118 is connectable. As the portable recording medium 118, an optical disc (for example, a compact disc (CD) or a digital versatile disc (DVD)), a semiconductor memory, or the like may be applied. The program for executing the processes of the host device 1 according to the embodiment may be stored in the portable recording medium 118.

The input device 116 is, for example, a keyboard, a pointing device, or the like and receives an instruction entered by a user, information entered by the user, and the like.

The output device 117 is, for example, a display device, a printer, a speaker, or the like and outputs an inquiry to the user or an instruction to the user, a process result, and the like.

The storage unit 11 illustrated in FIG. 2 may be enabled by the memory 112, the auxiliary storage device 113, the portable recording medium 118, or the like. The receiving unit 12, the determining unit 13, the transmitting unit 14, and the mutual communication processing unit 15 that are illustrated in FIG. 2 may be enabled by causing the processor 111 to execute the program loaded in the memory 112.

The memory 112, the auxiliary storage device 113, and the portable recording medium 118 are non-transitory computer-readable tangible storage media and are not transitory media such as signal carrier waves.

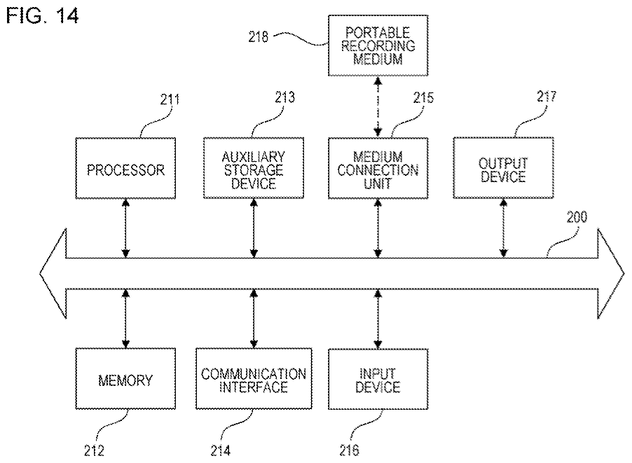

FIG. 14 is a diagram illustrating an example of the hardware configuration of the information processing device 2. As illustrated in FIG. 14, in the information processing device 2, a processor 211, a memory 212, an auxiliary storage device 213, a communication interface 214, a medium connection unit 215, an input device 216, and an output device 217 are coupled to a bus 200.

The processor 211 executes a program loaded in the memory 212. As the program to be executed, a program for executing the processes of the information processing device 2 according to the embodiment may be applied.

The memory 212 is, for example, a RAM. The auxiliary storage device 213 stores various types of information. As the auxiliary storage device 213, a hard disk drive, a semiconductor memory, or the like may be applied, for example. The program for executing the processes of the information processing device 2 according to the embodiment may be stored in the auxiliary storage device 213.

The communication interface 214 is coupled to a communication network such as a LAN or a WAN and converts data for communication. When the receiving unit 22 receives various types of information from a host device 1, and the transmitting unit 24 transmits various types of information to the host device 1, the information processing device 2 communicates with the host device 1 via the communication interface 214.

The medium connection unit 215 is an interface to which a portable recording medium 218 is connectable. As the portable recording medium 218, an optical disc (for example, a CD or a DVD), a semiconductor memory, or the like may be applied. The program for executing the processes of the information processing device 2 according to the embodiment may be stored in the portable recording medium 218.

The input device 216 is, for example, a keyboard, a pointing device, or the like and receives an instruction entered by a user, information entered by the user, and the like.

The output device 217 is, for example, a display device, a printer, a speaker, or the like and outputs an inquiry to the user or an instruction to the user, a process result, and the like.

The storage unit 21 illustrated in FIG. 3 may be enabled by the memory 212, the auxiliary storage device 213, the portable recording medium 218, or the like. The receiving unit 22, the determining unit 23, the transmitting unit 24, the program managing unit 25, the application processing unit 26, and the mutual communication processing unit 27 that are illustrated in FIG. 3 may be enabled by causing the processor 211 to execute the program loaded in the memory 212.

The memory 212, the auxiliary storage device 213, and the portable recording medium 218 are non-transitory computer-readable tangible storage media and are not transitory media such as signal carrier waves.

The embodiment is not limited to the above description, and various changes, additions, and omissions are applicable without departing from the gist of the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
an information processing device; and
a plurality of higher-level devices with which the information processing device communicates, wherein:
the information processing device includes a first memory and a first processor coupled to the first memory, the first memory being configured to store a plurality of first programs applicable to the information processing device, the first processor being configured to, when a connection process is executed between each of the plurality of higher-level devices and the information processing device, transmit, to the higher-level device, management information that includes program information indicating the plurality of first programs stored in the first memory; and
each of the plurality of higher-level devices includes a second memory and a second processor coupled to the second memory, the second memory being configured to store a predetermined first program that is applicable to the information processing device and associated with a second program applied to the higher-level device, wherein
the second processor of the higher-level device is configured to:
determine whether the predetermined first program is to be transmitted to the information processing device, based on whether the program information received from the information processing device includes information on the predetermined first program, and
transmit, to the information processing device, an instruction for causing the information processing device to apply the predetermined first program when the second processor of the higher-level device determines that the predetermined first program is not to be transmitted to the information processing device.

2. The information processing system of claim 1, wherein:
the management information is configured to include information indicating a first program currently applied to the information processing device; and
when the first program currently applied to the information processing device is different from the predetermined first program and the program information includes information on the predetermined first program, the second processor of the higher-level device determines that the predetermined first program is not to be transmitted to the information processing device, and transmits, to the information processing device, an instruction for causing the information processing device to apply the predetermined first program stored in the information processing device.

3. The information processing system of claim 1, wherein:
the management information is configured to include information indicating a first program currently applied to the information processing device; and
when the first program currently applied to the information processing device is different from the predetermined first program, and the program information does not include information on the predetermined first program, the second processor of the first higher-level device determines that the predetermined first program is to be transmitted to the information processing device, and transmits the predetermined first program to the information processing device.

4. The information processing system of claim 1, wherein:
the management information is configured to include information indicating a first program currently applied to the information processing device; and
when the first program currently applied to the information processing device matches the predetermined first program, the second processor of the higher-level device determines that the predetermined first program is not to be transmitted to the information processing device, and starts a predetermined mutual communication process between the higher-level device and the information processing device.

5. The information processing system of claim 3, wherein
the first processor of the information processing device is configured to:
upon receiving the predetermined first program from the higher-level device when a number of the plurality of first programs stored in the first memory is equal to a predetermined value, delete a first program used at an earliest time point among time points at which the plurality of first programs stored in the first memory were used last, and
store the received predetermined first program in the first memory.

6. A higher-level device included in an information processing system in which an information processing device communicates with a plurality of higher-level devices, the higher-level device comprising:
a memory configured to store a predetermined first program associated with a second program applied to the higher-level device, and
a processor coupled to the memory and configured to:
transmit, to the information processing device, an instruction for causing the information processing device to transmit management information that includes program information indicating a plurality of first programs that are applicable to the information processing device and stored in the information processing device,
determine whether the predetermined first program is to be transmitted to the information processing device, based on whether the program information received from the information processing device includes information on the predetermined first program, and
when the processor has determined that the predetermined first program is not to be transmitted to the information processing device, transmit, to the information processing device, an instruction for causing the information processing device to apply the predetermined first program.

7. The higher-level device of claim 6, wherein:
the management information is configured to include information indicating a first program currently applied to the information processing device;
when the first program currently applied to the information processing device is different from the predetermined first program and the management information includes information indicating the predetermined first program, the processor determines that the predetermined first program is not to be transmitted to the information processing device, and transmits, to the information processing device, an instruction for causing the information processing device to apply the predetermined first program stored in the information processing device.

8. The higher-level device of claim 6, wherein:
the management information is configured to include information indicating a first program currently applied to the information processing device; and
when the first program currently applied to the information processing device is different from the predetermined first program and the program information does not include information on the predetermined first program, the processor determines that the predetermined first program is to be transmitted to the information processing device, and transmits the predetermined first program to the information processing device.

9. The higher-level device of claim 6, wherein:
the management information is configured to include information indicating a first program currently applied to the information processing device; and
when the first program currently applied to the information processing device matches the predetermined first program, the processor determines that the predetermined first program is not to be transmitted to the information processing device, and starts a predetermined mutual communication process between the higher-level device and the information processing device.

10. An information processing device included in an information processing system in which the information processing device communicates with a plurality of higher-level devices, the information processing device comprising:
a memory configured to store a plurality of first programs applicable to the information processing device; and
a processor coupled to the memory and configured to:
when a connection process is executed between each of the plurality of higher-level devices and the information processing device, transmit, to the higher-level device, management information that includes program information indicating the plurality of first programs stored in the memory, and
upon receiving, from the higher-level device, an instruction for causing the information processing device to apply a predetermined first program among the plurality of first programs, apply the predetermined first program to the information processing device.

11. The information processing device of claim 10, wherein:
the management information is configured to include information indicating a first program currently applied to the information processing device; and
when the first program currently applied to the information processing device is different from the predetermined first program and the program information does not include information on the predetermined first program, the processor receives the predetermined first program from the higher-level device, and applies the received predetermined first program to the information processing device.

12. The information processing device of claim 10, wherein:
the management information is configured to include information indicating a first program currently applied to the information processing device; and
the processor is configured to, when the first program currently applied to the information processing device matches the predetermined first program, start a predetermined mutual communication process between the higher-level device and the information processing device.

13. The information processing device of claim 10, wherein the processor is configured to:
upon receiving the predetermined first program from the higher-level device when a number of the plurality of first programs stored in the memory is equal to a predetermined value, delete a first program used at an earliest time point among time points at which the plurality of first programs stored in the memory were used last, and
store the received predetermined first program in the memory.
